(19) United States
(12) Patent Application Publication
(10) Pub. No.: US 2011/0093848 A1
(43) Pub. Date: Apr. 21, 2011

(54) SYSTEM FOR IMPROVING A USER-SPACE ENVIRONMENT

(75) Inventors: Khalid Filali-Adib, Austin, TX (US); Perinkulam I. Ganesh, Round Rock, TX (US); Paul D. Mazzurana, Austin, TX (US); Edward Shvartsman, Austin, TX (US); Sunjin Yook, Austin, TX (US)

(73) Assignee: International Business Machines Corporation, Armonk, NY (US)

(21) Appl. No.: 12/581,866

(22) Filed: Oct. 19, 2009

(51) Int. Cl. G06F 9/455; G06F 15/177

(52) U.S. Cl. 718/1; 713/2

(57) ABSTRACT

A system to improve a user-space environment may include a user-space configured to execute on an operating system-level virtualization. The system may also include a boot module configured to boot up the user-space on the operating system-level virtualization without disrupting the operating system-level virtualization even if the operating system-level virtualization is already running.

### CROSS-REFERENCE TO RELATED APPLICATIONS

This application is related to copending application U.S. patent application Ser. No. ______ (Attorney Docket No. AUS920090206US1).

### BACKGROUND OF THE INVENTION

1. Field of the Invention

The invention relates to the field of computer systems, and, more particularly, to improving a user-space of an operating system-level virtualization.

2. Description of Background

Generally, a Software Workload Partition (“WPAR”) provides isolation of software services, applications and administration utilizing flexible software-defined boundaries for a user-space within a single instance of operating system. A software partition has the look and feel of a stand-alone system. It can be booted, accessed, and/or shutdown like a stand-alone machine. The very first environment, e.g. the traditional operating system (“OS”), on top of which WPARS are created is called the global. Normally for such partitions the file system data and boot information are stored on the local hard disks and it boots from the local disks.

For the sake of mobility of WPARS, the entire file system should reside on a Network and so that it can be accessed from the departure and arrival machine accessed using standard protocols. Implementation of a network file system (“NFS”) based WPAR user-space is where all of the file systems of the WPAR are created off of the NFS.

### SUMMARY OF THE INVENTION

A system to improve a user-space environment may include a user-space configured to execute on an operating system-level virtualization. The system may also include a boot module configured to boot up the user-space on the operating system-level virtualization without disrupting the operating system-level virtualization even if the operating system-level virtualization is already running.

The operating system-level virtualization may execute on a first physical device, and the boot module may execute on a second physical device. The boot module may include a root volume group. The boot module may include logical volume names that substantially match operating system-level virtualization logical volume names.

The user-space may execute processes based upon images on the second physical device. The user-space may be associated with a physical storage device that carries a root volume group that is based upon the user-space. The root volume group may include user-space core file systems provided from the operating system-level virtualization.

The boot module may include object data manager data and second physical device data. The object data manager data and second physical device data may be used and/or updated when the second physical device is configured during the boot up.

Another aspect of the invention is a method that may improve a user-space environment. The method may include executing a user-space on an operating system-level virtualization. The method may also include booting up the user-space on the operating system-level virtualization without disrupting the operating system-level virtualization even if the operating system-level virtualization is already running.

The method may include executing the operating system-level virtualization on a first physical device and the boot module on a second physical device. The method may also include substantially matching logical volume names on the boot module with operating system-level virtualization logical volume names.

The method may include executing user-space processes based upon images on the second physical device. The method may further include associating the user-space with a physical storage device that carries a root volume group that is based upon the user-space.

The method may include providing from the operating system-level virtualization a root volume group that includes user-space core file systems. The method may also include using and/or updating object data manager data and second physical device data when the second physical device is configured during the boot up.

Another aspect of the invention is a computer program product that may improve a user-space. The computer program product may include a computer readable storage medium having computer readable program code embodied therewith, the computer readable program code comprising computer readable program code that may be configured to execute a user-space on an operating system-level virtualization. The computer readable program code may also be configured to boot up the user-space on the operating system-level virtualization without disrupting the operating system-level virtualization even if the operating system-level virtualization is already running.

Another aspect of the invention is an embodiment in which a user-space may be configured to execute on an operating system-level virtualization when executing on a first physical device. The embodiment may include a boot module configured to execute on a second physical device and boot up the user-space on the operating system-level virtualization without disrupting the operating system-level virtualization even if the operating system-level virtualization is already running, and the boot module includes logical volume names that substantially match operating system-level virtualization logical volume names.

### BRIEF DESCRIPTION OF THE DRAWINGS

FIG. 1 is a schematic block diagram of a system to improve a user-space in accordance with the invention.

FIG. 2 is a flowchart illustrating method aspects according to the invention.

FIG. 3 is a flowchart illustrating method aspects according to the method of FIG. 2.

FIG. 4 is a flowchart illustrating method aspects according to the method of FIG. 2.

FIG. 5 is a flowchart illustrating method aspects according to the method of FIG. 2.

FIG. 6 is a flowchart illustrating method aspects according to the method of FIG. 5.

FIG. 7 is a flowchart illustrating method aspects according to the method of FIG. 2.

FIG. 8 is a flowchart illustrating method aspects according to the method of FIG. 3.

### DETAILED DESCRIPTION OF THE INVENTION

The invention will now be described more fully hereinafter with reference to the accompanying drawings, in which preferred embodiments of the invention are shown. Like numbers refer to like elements throughout, like numbers with letter suffixes are used to identify similar parts in a single embodiment, letter suffix lower case n is a variable that indicates an unlimited number of similar elements, and prime notations are used to indicate similar elements in alternative embodiments.

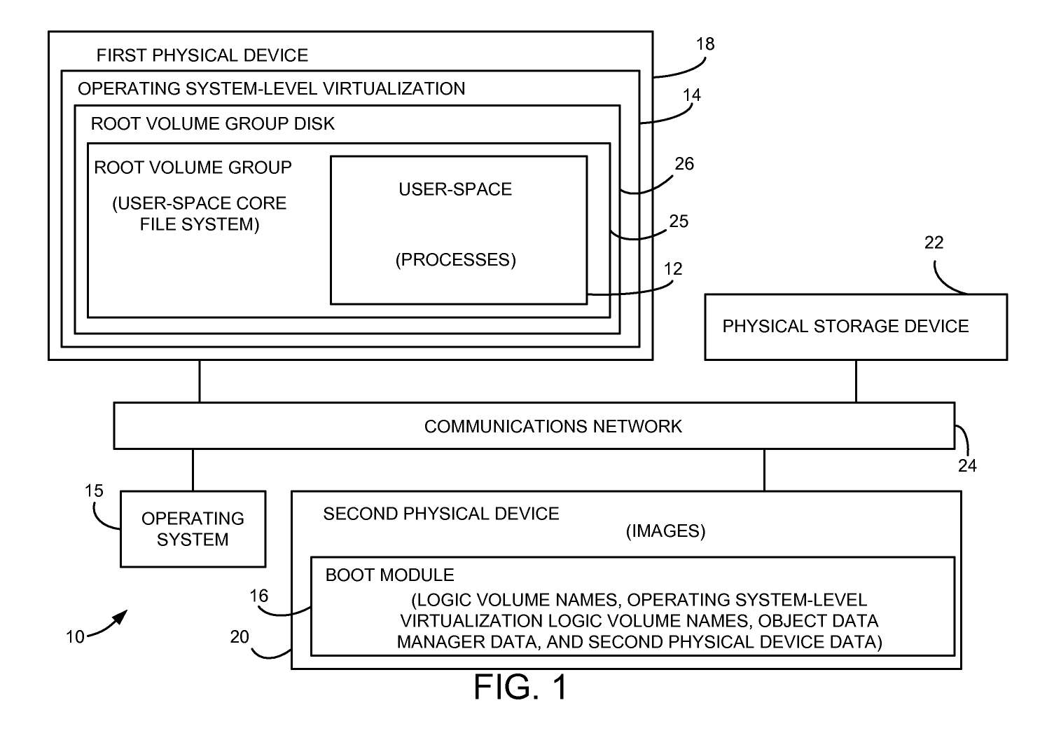

With reference now to FIG. 1, a system 10 to improve a user-space is initially described. The system 10 is a programmable apparatus that stores and manipulates data according to an instruction set as will be appreciated by those of skill in the art.

According to one embodiment of the invention, the system 10 includes a user-space 12 configured to execute on an operating system-level virtualization 14. In another embodiment, the system 10 includes a boot module 16 configured to boot up the user-space 12 on the operating system-level virtualization 14 without disrupting the operating system-level virtualization even if the operating system-level virtualization is already running.

In one embodiment, the operating system-level virtualization 14 executes on a first physical device 18, and the boot module 16 executes on a second physical device 20. In another embodiment, the boot module 16 includes a root volume group 25. In another embodiment, the boot module 16 includes logical volume names that substantially match operating system-level virtualization 14 logical volume names.

In one embodiment, the user-space 12 executes processes based upon images on the second physical device 20. In another embodiment, the user-space 12 is associated with a physical storage device 22 and a root volume group 25 that is based upon the user-space 12. In another embodiment, the root volume group 25 includes user-space 12 core file systems provided from the operating system-level virtualization 14. In another embodiment, the root volume disk 26 contains the root volume group 25.

In one embodiment, the boot module 16 includes object data manager data and second physical device 20 data. In another embodiment, the object data manager data and physical storage device 22 data is used and/or updated when the first physical device is configured during the boot up.

In one embodiment, the system 10 includes a communications network 24, which enables a signal to travel anywhere within system 10 and/or to any other system connected to system 10. The communications network 24 is wired and/or wireless, for example. The communications network 24 is local and/or global with respect to system 10, for instance.

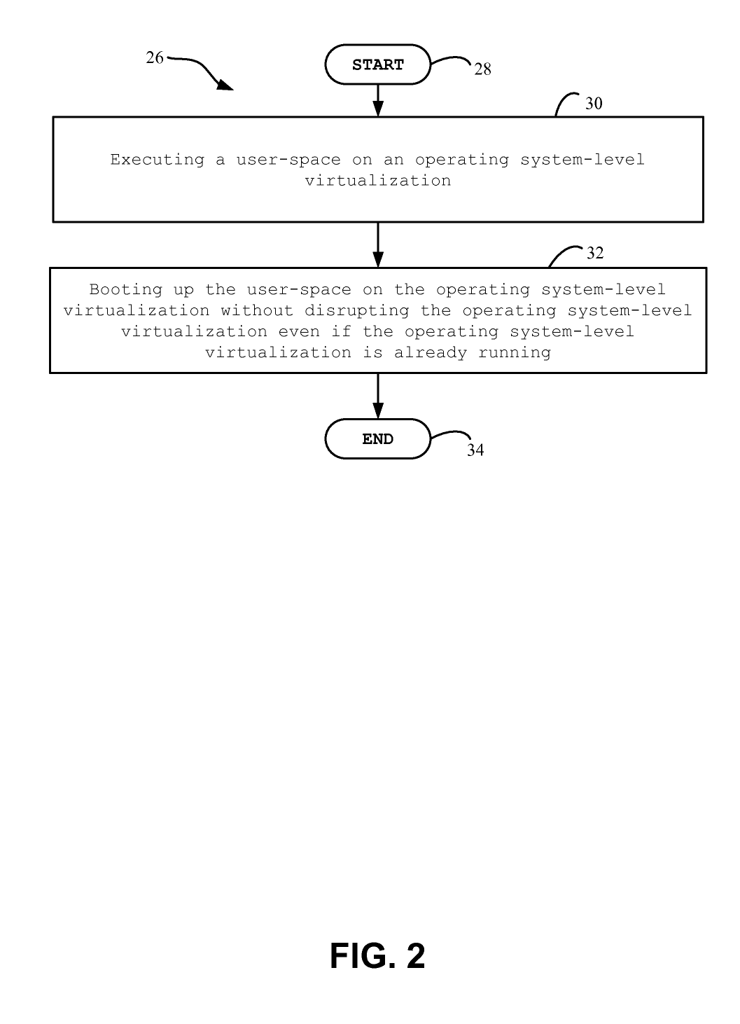

Another aspect of the invention is a method to improve a user-space, which is now described with reference to flowchart 26 of FIG. 2. The method begins at Block 28 and may include executing a user-space on an operating system-level virtualization at Block 30. The method may also include booting up the user-space on the operating system-level virtualization without disrupting the operating system-level virtualization even if the operating system-level virtualization is already running at Block 32. The method ends at Block 34.

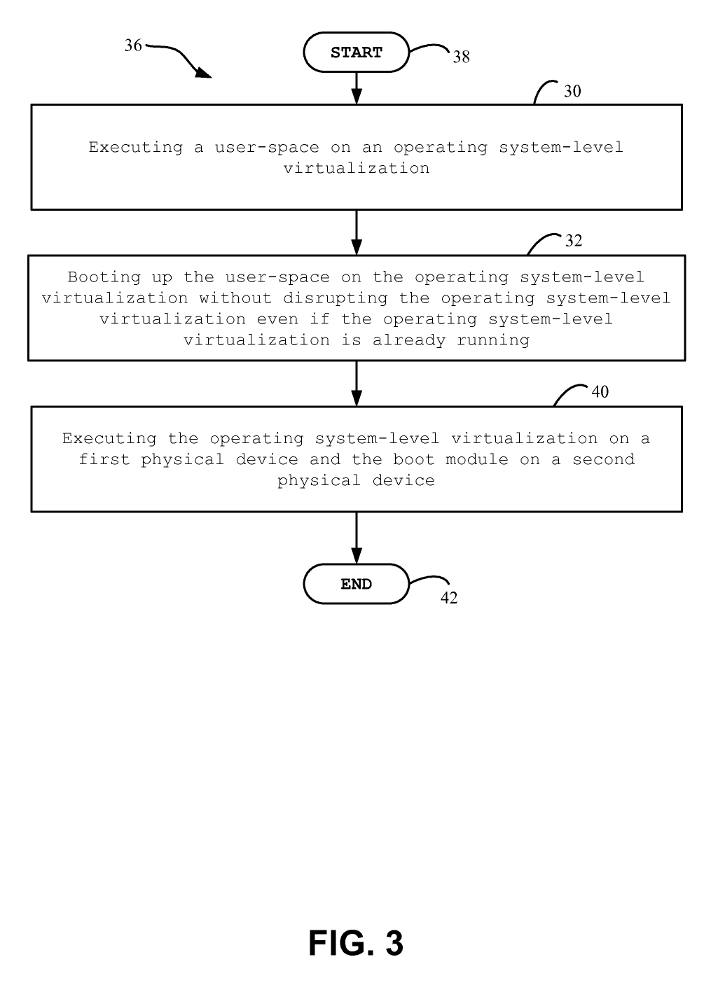

In another method embodiment, which is now described with reference to flowchart 36 of FIG. 3, the method begins at Block 38. The method may include the steps of FIG. 2 at Blocks 30 and 32. The method may additionally include executing the operating system-level virtualization on a first physical device and the boot module on a second physical device at Block 40. The method ends at Block 42.

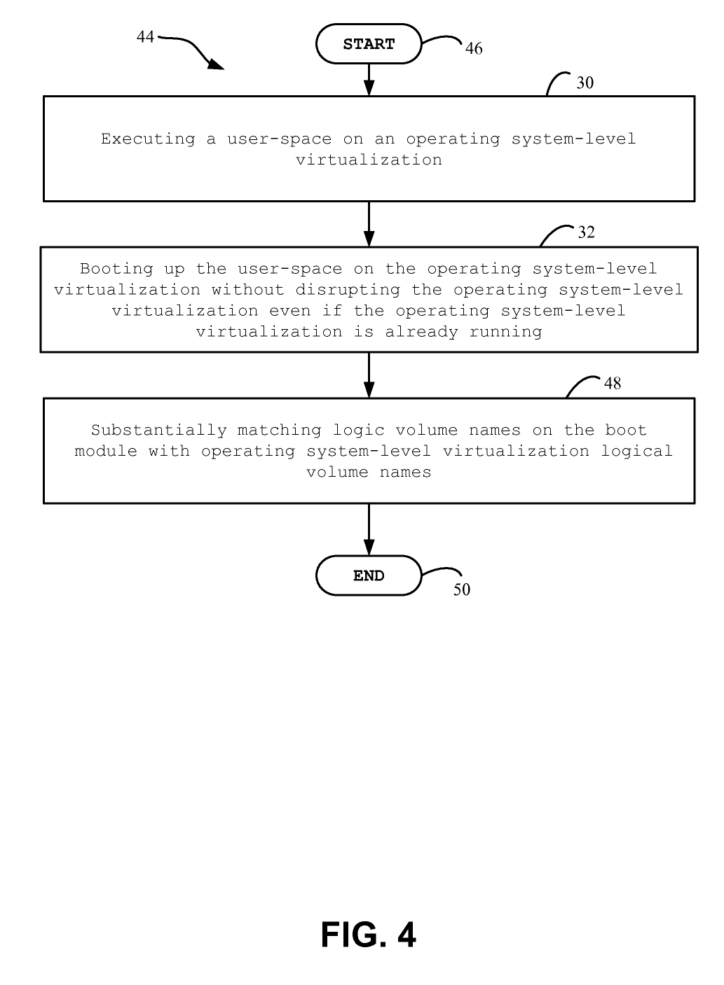

In another method embodiment, which is now described with reference to flowchart 44 of FIG. 4, the method begins at Block 46. The method may include the steps of FIG. 2 at Blocks 30 and 32. The method may additionally include substantially matching logical volume names on the boot module with operating system-level virtualization logical volume names at Block 48. The method ends at Block 50.

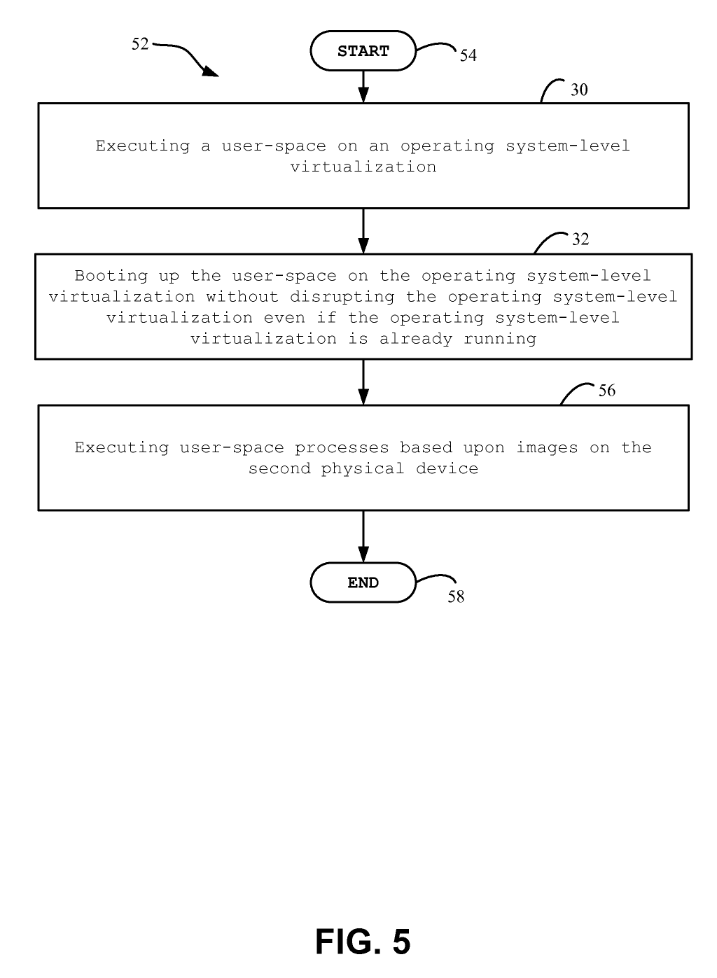

In another method embodiment, which is now described with reference to flowchart 52 of FIG. 5, the method begins at Block 54. The method may include the steps of FIG. 2 at Blocks 30 and 32. The method may additionally include executing user-space processes based upon images on the second physical device at Block 56. The method ends at Block 58.

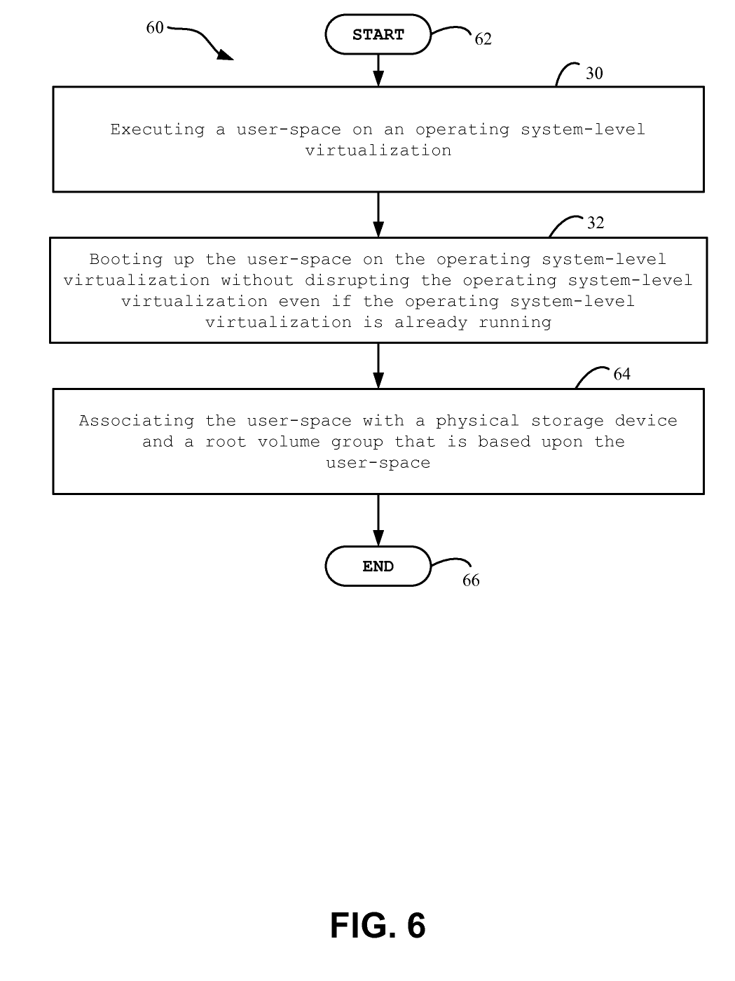

In another method embodiment, which is now described with reference to flowchart 60 of FIG. 6, the method begins at Block 62. The method may include the steps of FIG. 2 at Blocks 30 and 32. The method may additionally include associating the user-space with a physical storage device that carries a root volume group that is based upon the user-space at Block 64. The method ends at Block 66.

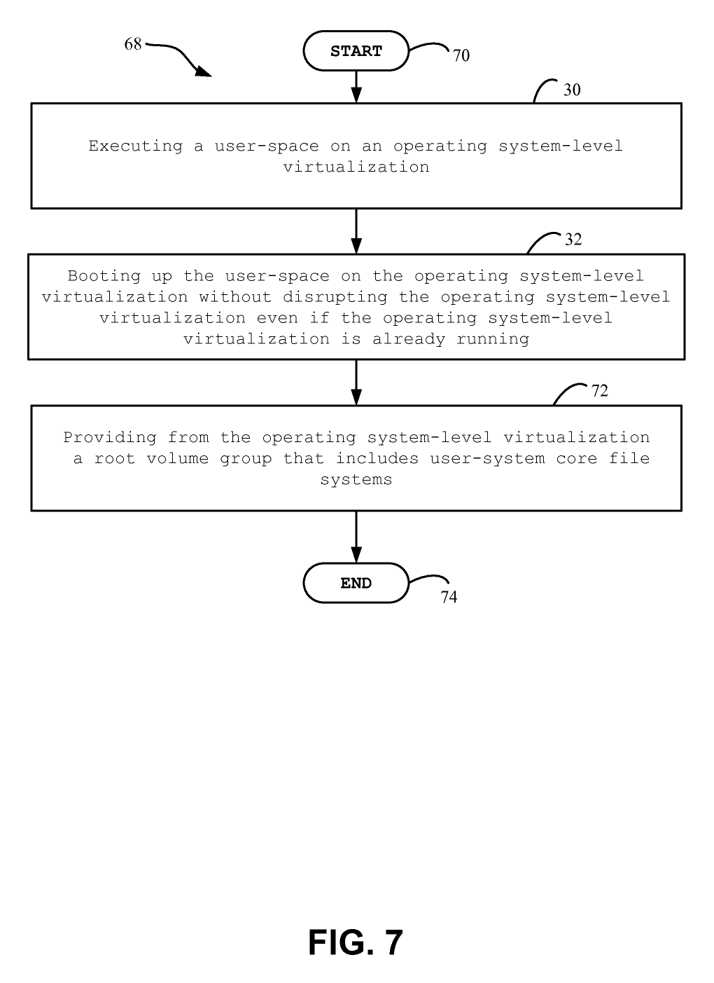

In another method embodiment, which is now described with reference to flowchart 68 of FIG. 7, the method begins at Block 70. The method may include the steps of FIG. 2 at Blocks 30 and 32. The method may additionally include providing from the operating system-level virtualization a root volume group that includes user-system core file systems at Block 72. The method ends at Block 74.

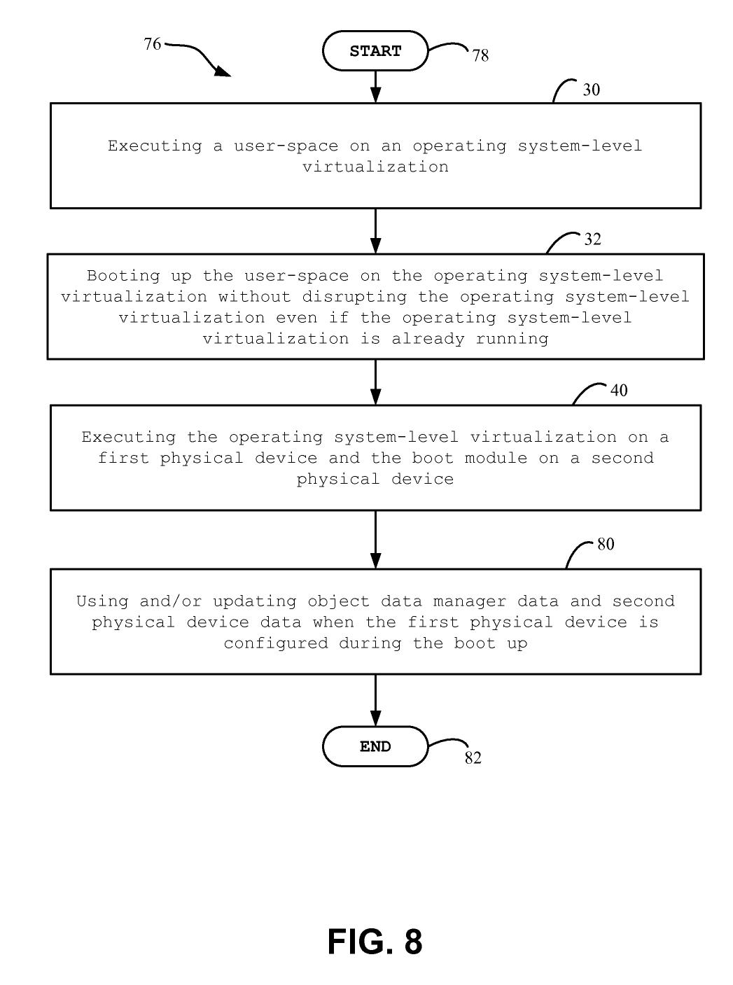

In another method embodiment, which is now described with reference to flowchart 76 of FIG. 8, the method begins at Block 78. The method may include the steps of FIG. 3 at Blocks 30, 32, and 40. The method may additionally include using and/or updating object data manager data and second physical device data when the second physical device is configured during the boot up at Block 80. The method ends at Block 82.

Another aspect of the invention is a computer program product that improves a user-space 12. In one embodiment, the computer program product includes a computer readable storage medium having computer readable program code embodied therewith, the computer readable program code comprising computer readable program code that is configured to execute a user-space 12 on an operating system-level virtualization 14. In another embodiment, the computer readable program code is configured to boot up the user-space 12 on the operating system-level virtualization 14 without disrupting the operating system-level virtualization even if the operating system-level virtualization is already running.

Another aspect of the invention is an embodiment in which a user-space 12 is configured to execute on an operating system-level virtualization 14 when executing on a first physical device 18. The embodiment may include a boot module 16 configured to execute on a second physical device 20 and boot up the user-space 12 on the operating system-level virtualization 14 without disrupting the operating system-level virtualization even if the operating system-level virtualization is already running, and the boot module includes logical volume names that substantially match operating system-level virtualization logical volume names.

In view of the foregoing, the system 10 addresses improving a user-space, for example. In one embodiment, system 10 provides a storage area network (“SAN”) based RootVG 25 WPAR user-space 12 and mobility of SAN based WPAR. In one embodiment, system 10 is implemented in AIX 61H to provide the SAN based RootVG 25 WPAR user-space 12 and SAN based WPAR mobility.

In one embodiment, a RootVG 25 WPAR user-space 12 has a number of characteristics. In another embodiment, the WPAR user-space 12 supports physical storage devices 22. In another embodiment, once a physical storage device 22 has been provided to a WPAR user-space 12, the WPAR has exclusive control over it.

In one embodiment, the physical storage device 22 can be varied on and varied off from within the WPAR user-space 12. In another embodiment, new logical volumes (“LV”) can be created on the physical storage device 22 and so forth.

In one embodiment, the WPAR user-space 12 has it's own rootvg volume group 25 (in the WPAR space). In another embodiment, the user-space 12 looks and feels like a standalone machine. In another embodiment, the user-space 12 supports the same LV names as on the global machine. By providing this feature the RootVG 25 WPAR can support an environment with the same “look and feel” as a respective global system. In other words, from inside the WPAR user-space 12, the namespace would look just like the global system namespace. For example, the root volume group 25 has the “rootvg” name as well as the same LVs on rootvg volume group, which resides on disk(s) within a WPAR user-space 12 as follows: /dev/hd4/; /dev/hd2/usr; /dev/hd9var /var; /dev/hd3/tmp; /dev/hd1 /home; /dev/hd11admin /admin; and /dev/hd10opt /opt.

In one embodiment, the WPAR user-space 12 boots from its own device, e.g. second physical device 20. The booting of a Software Partition, e.g. user-space 12, from its own device has a number of considerations.

In one embodiment, user-space 12 booted on top of a fully booted system, the booting process does not disrupt the functioning of the global or other WPARs running on the same hardware. In another embodiment, the boot module 16 is a lightweight boot up process and does not introduce additional protocols.

In one embodiment, the WPAR user-space 12 should be able to boot up from any server. In another embodiment, there are no special configurations for the server other than providing the device into the WPAR user-space 12.

In one embodiment, the processes executed with the WPAR user-space 12 get their image from their device, e.g. first physical device 18. In another embodiment, user-space 12 makes uses of the kernel portion as the kernel is shared across the system 10.

This may seem similar to a booting using non-volatile random access memory (“NVRAM”). However, there are marked differences between booting off of a NVRAM boot list and the booting of a device provided to the software partition.

For instance, a NVRAM boot has no knowledge of the system, it is stand alone, and boots from scratch reading the boot logical volume (“BLV”) from the boot device. The boot code found in the BLV is used to load the kernel and create a file system (“FS”) in memory called the RAM FS.

In contrast, for a RootVG 25 WPAR user-space 12, the base OS 15 (which it shares with the global) has already booted and is functional. The user-space 12 partition has to be booted on top of the existing OS 15. It cannot read a BLV to boot from scratch or create a RAMFS.

In one embodiment, at the time of WPAR user-space 12 creation, a set of disks are specified as rootvg 25 disks. In another embodiment, these disks are populated with WPAR user-space 12 core file systems. In another embodiment, the disks are provided from global space, which causes the global to lose all knowledge on the RoogtVG 25 WPAR's core filesystems and root volume group. In another embodiment, the WPAR user-space 12 cannot be directly booted off of these disks.

In one embodiment, to boot a very light weight version of skeletal WPAR user-space 12 is created on a scratch file system (“SFS”), which contains just enough information to make WPAR rootvg 25 disks and data disks available. In another embodiment, after booting off of this SFS, a process is run which brands and chroots itself into the WPAR user-space 12 and runs the device configuration manager (“cfgmgr”). This configures the wio0, fscsi0, and hdisk0 and/or the like. This results in object data manager (“ODM”) information for the given devices being stored on the SFS.

In one embodiment, now system 10 performs an import volume group (“VG”). In another embodiment, if system 10 has a private /usr, then system 10 brands (no chroot) and mount the WPAR's /dev/hd2 over /wpars/foo/SFS/usr.

In one embodiment, if system 10 does not have a private /usr, then system 10 brands (no chroot) and namefs mount the Global's /usr over /wpars/foo/SFS/usr. In another embodiment, now system 10 mounts WPARS /dev/hd4 over /wpars/foo/mnt and merge the ODM onto the WPAR owned storage device (/etc/objrepos of the WPAR). In another embodiment, then system 10 unmount /mnt and mount the rest of the file systems.

In one embodiment, system 10 also maintains a “boot window” from the WPAR into the Global. In another embodiment, the savebase command is run to record the base customized data to this directory. In another embodiment, then the WPARs /etc/rc.bootc is executed.

In one embodiment, at the time of RootVG 25 WPAR shutdown, the most recent customized ODM data and device information will be recorded to the wboot window. In another embodiment, the file systems of the WPAR user-space 12 are then unmounted and the volume groups of the WPAR are varied off.

In one embodiment, the ODM information recorded to the wboot window is then transferred onto the SFS. In another embodiment, the devices of the WPAR user-space 12 are then unconfigured using this new ODM information. In another embodiment, this step makes it possible to add/change/remove devices since the WPAR user-space 12 was started and the SFS version of ODM will not have knowledge of any ODM modifications once the SFS is overmounded with the file systems of the WPAR.

In one embodiment, when RootVG 25 WPAR boots up, the ODM data and device information that were saved in wboot window will be used/updated when the devices are then configured as part of the WPAR user-space 12 boot process. Thus RootVG 25 WPAR's device information stays in sync with the SFS and the WPAR storage device, e.g. physical storage device 22, contents.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
a user-space configured to execute on an operating system-level virtualization; and
a boot module configured to boot up the user-space on the operating system-level virtualization without disrupting the operating system-level virtualization even if the operating system-level virtualization is already running.

2. The system of claim 1 wherein the operating system-level virtualization executes on a first physical device; and wherein the boot module executes on a second physical device.

3. The system of claim 1 wherein the boot module comprises a root volume group.

4. The system of claim 1 wherein the boot module comprises logical volume names that substantially match operating system-level virtualization logical volume names.

5. The system of claim 2 wherein the user-space executes processes based upon images on the second physical device.

6. The system of claim 1 wherein the user-space is associated with a physical storage device and a root volume group that is based upon the user-space.

7. The system of claim 6 wherein the root volume group comprises user-space core file systems provided from the operating system-level virtualization.

8. The system of claim 2 wherein the boot module comprises object data manager data and second physical device data.

9. The system of claim 8 wherein the object data manager data and second physical device data are at least one of used and updated when the first physical device is configured during the boot up.

10. A method comprising:
executing a user-space on an operating system-level virtualization; and
booting up the user-space on the operating system-level virtualization without disrupting the operating system-level virtualization even if the operating system-level virtualization is already running.

11. The method of claim 10 further comprising executing the operating system-level virtualization on a first physical device and the boot module on a second physical device.

12. The method of claim 10 further comprising substantially matching logical volume names on the boot module with operating system-level virtualization logical volume names.

13. The method of claim 10 further comprising executing user-space processes based upon images on the second physical device.

14. The method of claim 10 further comprising associating the user-space with a physical storage device and a root volume group that is based upon the user-space.

15. The method of claim 10 further comprising providing from the operating system-level virtualization a root volume group that includes user-space core file systems.

16. The method of claim 11 further comprising at least one of using and updating object data manager data and physical storage device data when the first physical device is configured during the boot up.

17. A computer program product to improve a user-space, the computer program product comprising:
a computer readable storage medium having computer readable program code embodied therewith, the computer readable program code comprising:
computer readable program code configured to execute a user-space on an operating system-level virtualization; and
computer readable program code configured to boot up the user-space on the operating system-level virtualization without disrupting the operating system-level virtualization even if the operating system-level virtualization is already running.

18. The computer program product of claim 17 further comprising computer readable program code configured to execute the operating system-level virtualization on a first physical device and the boot module on a second physical device, and to at least one of use and update object data manager data and second physical device data when the first physical device is configured during the boot up.

19. The computer program product of claim 17 further comprising computer readable program code configured to substantially match logical volume names on the boot module with operating system-level virtualization logical volume names.

20. The computer program product of claim 17 further comprising computer readable program code configured to execute user-space processes based upon images on the second physical device.

21. The computer program product of claim 17 further comprising computer readable program code configured to associate the user-space with a physical storage device and a root volume group that is based upon the user-space.

22. The computer program product of claim 17 further comprising computer readable program code configured to provide from the operating system-level virtualization a root volume group that includes user-space core file systems.

23. The computer program product of claim 17 further comprising computer readable program code configured to at least one of use and update object data manager data and second physical device data when the second physical device is configured during the boot up.

24. A system comprising:
a user-space configured to execute on an operating system-level virtualization when executing on a first physical device; and
a boot module configured to execute on a second physical device and boot up the user-space on the operating system-level virtualization without disrupting the operating system-level virtualization even if the operating system-level virtualization is already running, and the boot module includes logical volume names that substantially match operating system-level virtualization logical volume names.

25. The system of claim 24 wherein the user-space executes processes based upon images on the second physical device.
